(19) United States
(12) Patent Application Publication
(10) Pub. No.: US 2025/0269766 A1
(43) Pub. Date: Aug. 28, 2025

(54) MOBILITY APPARATUS AND METHOD FOR CONTROLLING A BATTERY IN A SCHEDULED START-UP

(71) Applicants: HYUNDAI MOTOR COMPANY, Seoul (KR); KIA CORPORATION, Seoul (KR)

(72) Inventors: Young Kwang Kim, Hwaseong-si (KR); Chang Eun Na, Hwaseong-si (KR)

(73) Assignees: HYUNDAI MOTOR COMPANY, Seoul (KR); KIA CORPORATION, Seoul (KR)

(21) Appl. No.: 18/915,752

(22) Filed: Oct. 15, 2024

(30) Foreign Application Priority Data
Feb. 27, 2024 (KR) 10-2024-0027831

(51) Int. Cl. B60L 58/27; B60L 58/12

(52) U.S. Cl. CPC B60L 58/27; B60L 58/12; B60L 2240/545; B60L 2240/62; B60L 2240/662; B60L 2250/14; B60L 2260/56

(57) ABSTRACT

A mobility apparatus and a method for controlling a battery in scheduled start-up are provided. The method includes receiving a scheduled start-up request that includes a command associated with indoor heating and a scheduling request of a mobility apparatus. The method also includes determining, in relation to battery temperature raising control, an order of a discharge temperature raising operation and a temperature raising operation of a power generation cell charging the battery, based on a battery charge state, when a cold start-up condition is satisfied. The method additionally includes controlling temperature raising of the battery by using the discharge temperature raising operation and the temperature raising operation of the power generation cell according to the order. The discharge temperature raising operation includes at least one of indoor heating processing and battery warm-up processing.

### CROSS REFERENCE TO RELATED APPLICATION

The present application claims priority to Korean Patent Application No. 10-2024-0027831, filed on Feb. 27, 2024, the entire contents of which are hereby incorporated herein by reference.

### BACKGROUND

### Technical Field

The present disclosure relates to a mobility apparatus and a method for controlling a battery for a scheduled start-up. More particularly, the present disclosure relates to a mobility apparatus and a method for controlling a battery for improving energy efficiency of a battery temperature raising process in a cold scheduled start-up.

### Description of the Related Art

Following the recent trend of requiring eco-friendly energy resources, most vehicles are being designed to operate by electric energy instead of fossil fuel. Conventionally, electric vehicles are provided in various types according to forms of energy sources. For example, depending on an energy source form, an electric vehicle may use only a high-voltage battery that outputs drive power by external charge or may utilize a fuel cell that is mounted along with a high-voltage battery and charges the battery.

Electric vehicles commonly use output power of batteries for travel drive and an operation of a vehicle load device. Output power of a battery may vary according to a charge state of the battery and an ambient temperature. The charge state may be, for example, a state of charge (SOC) or a charged amount. Maximum output power of a battery may be reduced in a cold condition, for example. In situations demanding high output of a high-voltage battery such as vehicle start-up, travel drive, and an operation of a high-load device like an air-conditioner, there may occur a phenomenon of drastic decrease in output power.

A user may initiate start-up to use a vehicle when riding the vehicle or may remotely have start-up scheduled at a future expected time. For example, start-up scheduling may be performed through a user device with an application for control incorporated therein. In the case of start-up when riding, the user may expect a decrease of output power of a battery based on an ambient temperature at the time of riding and thus perceive degradation of performance during an operation that demands a lot of battery power. However, in the case of scheduled start-up, the user can may not know a temperature at a scheduled start-up time. If an ambient temperature is excessively low when the scheduled start-up is initiated, the user who rides in the vehicle at the scheduled time may experience an unexpected situation of degraded performance in travel drive, braking, and air-conditioning functions that require a high output of the battery. Cold scheduled start-up may thus cause the problem of unstable drive and air-conditioning performance.

### SUMMARY

Aspects of the present disclosure provide a mobility apparatus and a method for controlling a battery to improve energy efficiency of a battery temperature raising process in cold scheduled start-up.

The technical problems solved by the present disclosure are not limited to the above technical problems. Other technical problems that are not described herein should be more clearly understood by a person having ordinary skill in the art to which the present disclosure pertains from the following description.

According to an embodiment of the present disclosure, a method for controlling a battery for scheduled start-up is provided. The method includes receiving a scheduled start-up request that includes a command associated with indoor heating and a scheduling request of a mobility apparatus. The method also includes determining, in relation to battery temperature raising control, an order of a discharge temperature raising operation and a temperature raising operation of a power generation cell charging the battery, based on a battery charge state, when a cold start-up condition is satisfied. The method additionally includes controlling temperature raising of the battery by using the discharge temperature raising operation and the temperature raising operation of the power generation cell according to the order, wherein the discharge temperature raising operation includes at least one of indoor heating processing and battery warm-up processing.

According to an embodiment of the present disclosure, the cold start-up condition may be satisfied when an ambient temperature is equal to or lower than a cold start-up temperature.

According to an embodiment of the present disclosure, determining the order based on the battery charge state may include determining the order based on a comparison between the battery charge state and a threshold charge state. The threshold charge state may be set based on a location of the mobility apparatus.

According to an embodiment of the present disclosure, the threshold charge state may be a charge state that is required according to a difference between a current altitude at the location and a highest altitude in a region within a predetermined range from the location.

According to an embodiment of the present disclosure, determining the order based on the battery charge state may include determining to execute temperature raising control of the battery in an order of the discharge temperature raising operation and the temperature raising operation of the power generation cell, when the battery charge state is equal or higher than the threshold charge state. Determining the order based on the battery charge state may also include determining to execute the temperature raising control of the battery in an order of the temperature raising operation of the power generation cell and the discharge temperature raising operation, when the battery charge state is lower than the threshold charge state.

According to an embodiment of the present disclosure, controlling the temperature raising of the battery may include deactivating the temperature raising control of the battery by the indoor heating processing, in response to absence of an indoor heating request in the command, occurrence of a non-execution state of the indoor heating processing, or completion of the indoor heating processing, and executing the battery temperature raising control by the battery warm-up processing.

According to an embodiment of the present disclosure, execution of the battery warm-up processing may be stopped when a water temperature heating the battery is equal to or higher than an upper temperature limit.

According to an embodiment of the present disclosure, controlling the temperature raising of the battery may be performed until a battery temperature reaches a target battery temperature. The battery temperature may be a lowest temperature among temperatures detected from a plurality of predetermined portions of the battery.

According to an embodiment of the present disclosure, when the order is determined as an order of the discharge temperature raising operation and the temperature raising operation of the power generation cell, the discharge temperature raising operation may be performed based on a time required for the temperature raising operation of the power generation cell and the battery temperature raising control.

According to an embodiment of the present disclosure, the temperature raising operation of the power generation cell may be performed until a cold start-up state condition of the power generation cell is satisfied.

According to another embodiment of the present disclosure, a mobility apparatus is provided. The mobility apparatus includes a battery configured to supply power to the mobility apparatus and a power generation cell configured to charge the battery. The mobility apparatus also includes a memory configured to store at least one instruction and a processor configured to execute the at least one instruction stored in the memory. The processor is configured to receive a scheduled start-up request that includes a command associated with indoor heating and a scheduling request of the mobility apparatus. The processor is also configured to determine, in relation to battery temperature raising control, an order of a discharge temperature raising operation and a temperature raising operation of a power generation cell charging the battery, based on a battery charge state, when a cold start-up condition is satisfied. The processor is further configured to control temperature raising of the battery by using the discharge temperature raising operation and the temperature raising operation of the power generation cell according to the order. The discharge temperature raising operation includes at least one of indoor heating processing and battery warm-up processing.

The features briefly summarized above are example aspects of the present disclosure. These features are not intended to limit the scope of the present disclosure.

The technical problems solved by the present disclosure are not limited to the above technical problems. Other technical problems that are not described herein should be more clearly understood by a person having ordinary skill in the art to which the present disclosure pertains from the following description.

According to aspects of the present disclosure, a mobility apparatus and a method for controlling a battery are provided. The mobility apparatus and the method may improve energy efficiency of a battery temperature raising process in cold scheduled start-up.

The effects obtainable from the present disclosure are not limited to the above-mentioned effects. Other effects not mentioned herein should be more clearly understood by those having ordinary skill in the art from the following descriptions.

### BRIEF DESCRIPTION OF THE DRAWINGS

FIG. 1 is a view illustrating a mobility apparatus communicating with another apparatus to transmit and receive data.

FIG. 2 is a view showing constituent modules of a mobility apparatus, according to an embodiment of the present disclosure.

FIG. 3 is a view illustrating modules constituting a battery temperature controller and a heating device, according to an embodiment of the present disclosure.

FIG. 4 is a flowchart of a battery controlling method for scheduled start-up, according to an embodiment of the present disclosure.

FIG. 5 is a flowchart of a method of identifying an indoor heating request, according to an embodiment of the present disclosure.

FIG. 6 is a view illustrating a table map of a threshold charge state, according to an embodiment of the present disclosure.

FIG. 7 is a flowchart of a process of processing a temperature raising operation of a power generation battery, according to an embodiment of the present disclosure.

FIG. 8 is a flowchart of a process of processing battery temperature raising that follows a discharge temperature raising operation, according to an embodiment of the present disclosure.

FIG. 9 is a flowchart of a process of processing an operation of indoor heating, according to an embodiment of the present disclosure.

FIG. 10 is a flowchart of a process of processing an operation of a battery temperature controller, according to an embodiment of the present disclosure.

FIG. 11 is a view schematically showing consumed currents, battery temperature rise, consumed currents of a battery warmer in accordance with conventional battery temperature raising control.

FIG. 12 is a view schematically showing consumed currents, battery temperature rise, consumed currents of a battery warmer in accordance with battery temperature raising control when a battery charge state is lower than a threshold charge state in this embodiment, according to an embodiment of the present disclosure.

FIG. 13 is a view schematically showing consumed currents, battery temperature rise, consumed currents of a battery warmer in accordance with battery temperature raising control when a battery charge state is higher than a threshold charge state, according to an embodiment of the present disclosure.

### DETAILED DESCRIPTION

Hereinafter, embodiments of the present disclosure are described in detail with reference to the accompanying drawings in order to enable those having ordinary skill in the art to easily implement embodiments of the present disclosure. However, the present disclosure may be implemented in various different ways. Accordingly, the present disclosure is not limited to the embodiments described therein.

In describing embodiments of the present disclosure, where it has been considered that a detailed specific description of well-known features, functions, or constructions may unnecessarily obscure the gist of the present disclosure, a detailed description thereof has been omitted. Further, the same constituent elements in the drawings are denoted by the same reference numerals, and a repeated description of the same elements has been omitted.

In the present disclosure, when an element is simply referred to as being “connected to”, “coupled to” or “linked to” another element, this may mean that the element is “directly connected to”, “directly coupled to” or “directly linked to” the other element or is connected to, coupled to, or linked to the other element with the one or more intervening elements present therebetween. In addition, when an element is described as “including,” “comprising,” “having,” or the like, another element, this means that the element may further include one or more other elements or components unless specifically stated otherwise.

In the present disclosure, the terms first, second, etc. are used to distinguish one element from another. Such terms do not limit the order or the degree of importance between the elements unless specifically mentioned. Accordingly, a first element in an embodiment could be termed a second element in another embodiment, without departing from the scope of the present disclosure. Similarly, a second element in an embodiment could be termed a first element in another embodiment, without departing from the scope of the present disclosure.

In the present disclosure, elements that are distinguished from each other are distinguished merely for clearly describing each feature. The distinctions do not necessarily mean that the elements are separated. For example, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements. Some of the elements may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them should become more apparent with reference to embodiments described below in detail in conjunction with the accompanying drawings. Embodiments, however, may be embodied in many different forms and should not be constructed as being limited to example embodiments set forth herein. Rather, these embodiments are provided in order to ensure that this disclosure is complete and fully conveys the scope of the disclosure to those having ordinary skill in the art.

In the present disclosure, each of phrases such as “A or B”, “at least one of A and B”, “at least one of A or B”, “A, B or C”, “at least one of A, B and C”, ““at least one of A, B or C” and “at least one of A, B, C or combination thereof” may include any one or all possible combinations of the items listed together in the corresponding one of the phrases.

In the present disclosure, expressions of location relations such as “upper”, “lower”, “left”, and “right” are employed for the convenience of explanation. In case drawings illustrated in the accompanying drawings are inversed, the location relations described in the specification may be inversely understood.

When a component, device, element, or the like of the present disclosure is described as having a purpose or performing an operation, function, or the like, the component, device, or element should be considered herein as being “configured to” meet that purpose or perform that operation or function.

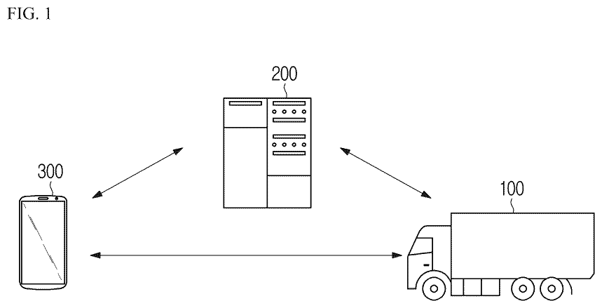

Hereinafter, referring to FIG. 1-3, a mobility apparatus implementing ambient temperature-based battery control in scheduled start-up, according to an embodiment of the present disclosure, is described. FIG. 1 is a view illustrating a mobility apparatus communicating with another apparatus to transmit and receive data, according to an embodiment.

Referring to FIG. 1, a mobility apparatus 100 (e.g., a vehicle) may be driven based on electric energy. For example, the mobility apparatus 100 may employ a high-voltage battery and a power generation cell charging the high-voltage battery as energy source. In case the power generation cell is a fuel cell, the mobility apparatus 100 may charge the high-voltage battery by power generation of the fuel cell and execute various functions required by the modules of the mobility apparatus 100 by output power of the high-voltage battery. In addition, the fuel cell may use various types of gas capable of generating electric energy. For example, the gas may be hydrogen. However, the present disclosure is not limited thereto. Various gases may be used. The present disclosure describes an example in which the mobility apparatus 100 is a fuel cell-based electric energy mobility apparatus. However, the present disclosure is applicable to a mobility apparatus where a high-voltage battery and a power generation cell are of different types and which employs a method of charging the high-voltage battery by power generation of the power generation cell to output power for the start-up, drive and accessories of the mobility apparatus 100.

The mobility apparatus 100 may refer to a device capable of moving. The mobility apparatus 100 may be a vehicle. The vehicle may be a ground vehicle that may be driven on the ground. The vehicle may be, for example, a typical passenger vehicle, a commercial vehicle, a mobile office, a mobile hotel, and/or the like. The vehicle may be a four-wheel vehicle, such as a sedan, a sports utility vehicle (SUV), a pickup truck, and/or the like. The vehicle may also be a vehicle with five or more wheels, such as a bus, a lorry, a container carrying vehicle, a heavy vehicle, and/or the like.

In some examples, the mobility apparatus 100 may be a manned or unmanned robot using a plurality of batteries such as a robot device for construction machinery.

In addition, the mobility apparatus 100 is not limited to a ground vehicle. For example, the mobility apparatus 100 may be an aerial vehicle using a battery or a water vehicle for water transportation. An aerial vehicle may include a manned flying object or an unmanned flying object. The unmanned flying object may be, for example, a drone, a personal aerial vehicle (PAV), an urban air mobility (UAM), and/or the like. A water vehicle may be a ship or submarine that is operated manned or unmanned, for example.

The mobility apparatus 100 may be implemented by manual operation or autonomous driving (either semi-autonomous or full-autonomous driving).

Hereinafter, for convenience of explanation, the mobility apparatus 100 is described as being a vehicle operating on the ground, and the mobility apparatus 100 is sometimes referred to herein as simply “vehicle.” However, embodiments of the present disclosure may be implemented in other mobility apparatuses, such as the various types of mobility apparatuses described above. As just an example, embodiments of the present disclosure may be implemented in an aerial vehicle or a water mobility vehicle.

In embodiments, the vehicle 100 may perform communication with another device or another mobility apparatus (e.g., another vehicle) under the control of a communication control unit (CTU) mounted in the vehicle 100. For example, the other device may include a server 200 for supporting various control, state management and driving of the vehicle 100, an intelligent transportation system (ITS) device 300 for receiving information from an intelligent transportation system, and/or various types of user devices 300.

The vehicle 100 may communicate with the other mobility apparatus or the other device based on cellular communication, wireless access in vehicular environment (WAVE) communication, dedicated short range communication (DSRC) or short range communication, and/or any other communication scheme.

For example, the vehicle 100 may use LTE as a cellular communication network, a communication network such as 5G, a WiFi communication network, a WAVE communication network, or the like to communicate with the server 200 and another mobility apparatus. By the above-described communication, the vehicle 100 may receive a request from the user device 300 via the server 200 and transmit a response to the request to the user device 300. The user device 300 may be a type of user device. In addition, DSRC used in the vehicle 100 may be used for communication between the vehicle 100 and other devices, such as other mobility apparatuses. In addition, the vehicle 100 may communicate with a type of user apparatus, such as a key fob or a smart key, by using short-range communication. For example, the short-range communication may be Bluetooth, infrared communication or near field communication (NFC). A communication scheme of the vehicle 100, the server 200, and the user device 300 is not limited to the above-described embodiment.

When responding to a request and data transmitted from the vehicle 100 and the user device 300, the server 200 may transmit various information and software modules used for controlling the vehicle 100 to the vehicle 100 and the user device 300. In addition, in order to remotely control a specific function requested by a user, the server 200 may be controlled to receive a remote control command for the vehicle 100 from the user device 300 and to implement a corresponding function of the vehicle 100. In embodiments of the present disclosure, as a response to a scheduled start-up request of the user device 300, the server 200 may control overall processing of scheduled start-up of the vehicle 100 and corresponding battery temperature raising.

The user device 300 may have an embedded application for processing of control and state management of the vehicle 100. A user may remotely request specific control processing to the vehicle 100 by using an application. For example, control-related processing may be start-up scheduling, start-up initiation/shut down, door open/close, air-conditioning scheduling/on-off/setting, cooling/heating control for a component of the vehicle 100 for riding and driving convenience, and/or battery charging door open/close. For example, state-related processing may be a charge state of a battery, a distance-to-empty, a location of the vehicle 100, and states of various components of the vehicle 100 such as doors, heating/cooling, air-conditioning, and indoor temperature states. Processing requests listed in the above-described examples may be transmitted the server 200. The server 200 may transmit a command according to a processing request to the vehicle 100. Further, the server 200 may receive a processing result for the request from the vehicle 100 and provide the processing result to an application. In addition, the user device 300 may be equipped with separate software for providing a simple control processing function to an authenticated user through short-range communication with the vehicle 100, for example when the user device 300 approaches the vehicle 100 within a predetermined distance range. Through the separate software, the user device 300 may directly communicate with the vehicle 100 without mediation of the server 200 and thus provide a simple function among the above-described control processing functions of the application to the user. Simple functions are only part of the above-described control processing functions and may be, for example, start-up initiation/shutdown, door open/close, battery charging door open/close, and the like.

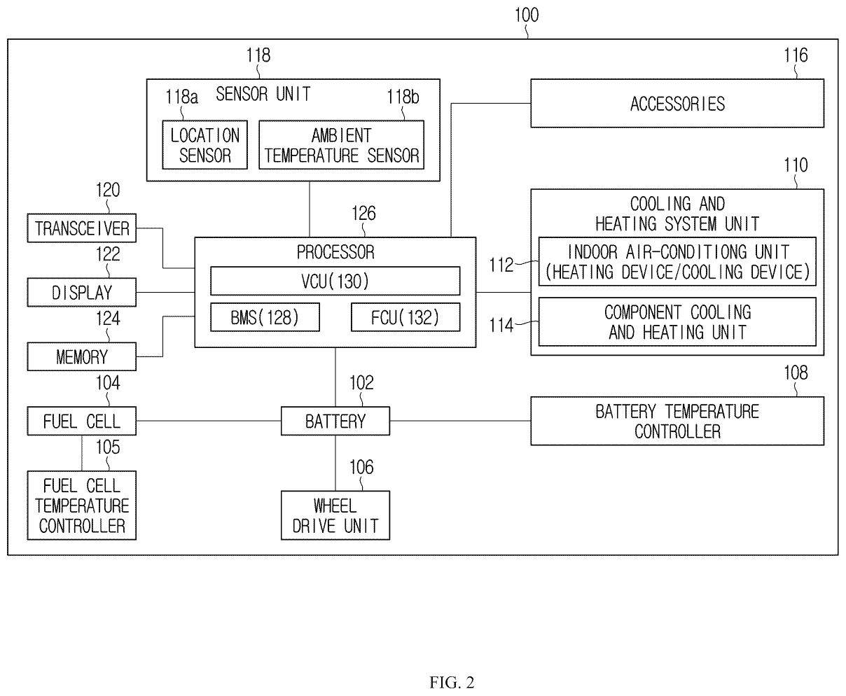

FIG. 2 is a view showing constituent modules of a mobility apparatus, such as a vehicle, according to an embodiment of the present disclosure.

The vehicle 100 may include a battery 102, a power generation cell 104, a wheel drive unit 106, a battery temperature controller 108, and a power generation cell temperature controller 105. In the present disclosure, for convenience of explanation, a power generation cell may be referred to as a fuel cell. The power generation cell and the power generation temperature controller may be referred to as a fuel cell and a fuel cell temperature controller, and these terms may be used interchangeably.

The battery 102 may be charged by electricity generation of the fuel cell 104 and also supply necessary power to a module of the vehicle 100. The battery 102 may be, for example, a high-voltage battery that is configured as a secondary cell. For example, the battery 102 may provide energy for the start-up and drive of the vehicle 100 and operations of load devices 110 and 116. Specifically, the battery 102 may provide energy applied from the fuel cell 104 for the start-up, drive, air-conditioning, component heating/cooling modules and various electrical devices of the vehicle 100. The battery 100 may output a higher voltage than the fuel cell 104 and supply energy to, for example, the wheel drive unit 106 and a high-power electric module. The fuel cell 104 may include a hydrogen fuel cell that generates electric energy through reaction between hydrogen supplied from a tank (not shown) and oxygen coming from outside. In addition, the fuel cell 104 may generate power according to a power generation amount determined based on power requirements of the start-up and travel drive and the load devices 110 and 116 and charge the battery 102 with the generated power. Furthermore, depending on a design specification, the fuel cell 104 may provide energy to a low-power electric module mounted in the vehicle 100. For example, the fuel cell 104 may be composed of a plurality of stacks, and power may be produced by each stack.

Although not illustrated in FIG. 2, the vehicle 100 may include a converter or other module serving as a step-up/step-down transformer. The converter or other module may convert and supply voltage from the fuel cell 104 to the battery 102, thereby charging the battery 102. According to an operating situation, the converter or other module may supply power at a converted voltage to the wheel drive unit 106 and various electronic devices that operate in a high-voltage range. For example, the electronic devices may be accessories 114.

The wheel drive unit 106 may be a module that receives power of the battery 102 and drives wheels. The wheel drive unit 106 may include a motor unit and a wheel unit. For example, every wheel unit may be driven by being connected with the motor unit. As another example, only some of the wheel units may be coupled with the motor unit, and the wheel units not coupled with the motor unit may be driven by the wheel units driven from a motor. A wheel unit may be equipped with a wheel and a wheel brake module. The wheel brake module may be a module that decreases the speed of a wheel by transmitting a braking force to the wheel at a deceleration control request of a driver or the processor 126.

The motor unit may generate a driving force by receiving electric power from the battery 102. As the motor transmits a driving force to a wheel unit, the wheel unit may be driven to rotate. For example, the motor unit may be equipped with a motor for transmitting a driving force to the wheel unit and a motor control module for controlling motor torque, a motor turning direction, and braking. The motor unit may be driven by electric power applied and supplied from the battery 102 via an inverter (not shown). The inverter may convert a specific form of electric power of the battery 102, such as alternating current, to another form, such as direct current and reduce a voltage. The inverter may also convert a predetermined form of reverse power of the motor unit caused by regenerative braking into a suitable form for the battery 102 and provide the power to the battery 102.

The battery temperature controller 108 may control the temperature of the battery 102 to a desired temperature through a coolant circulating around the battery 102 or direct heat transfer and thus heat or cool the battery 102. The battery temperature controller 108 may be equipped with a plurality of modules that control the temperature of the battery 102. In the present disclosure, for convenience of description, temperature raising processing of the battery 102 by the battery temperature controller 108 may be referred to as battery warm-up processing.

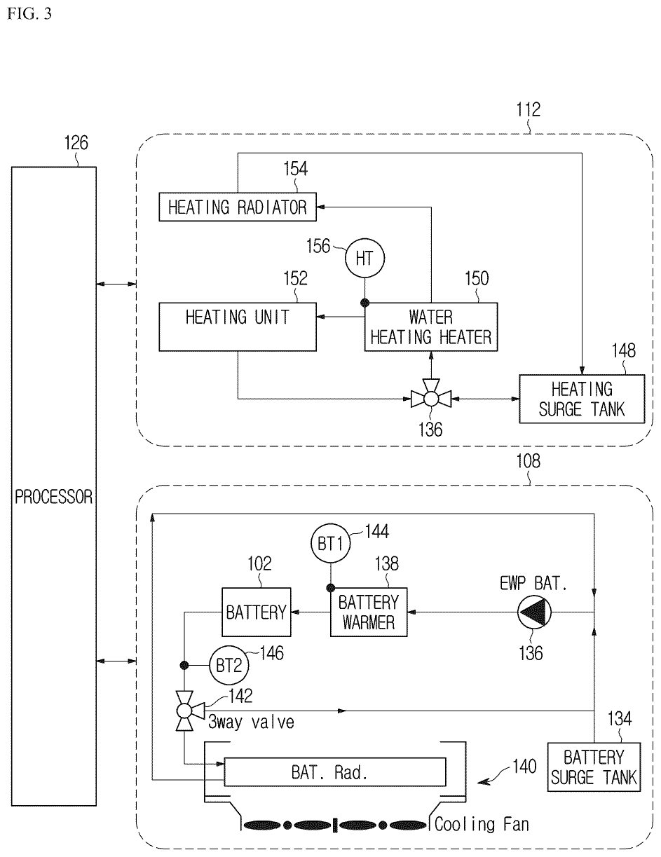

FIG. 3 is a view illustrating modules constituting a battery temperature controller and a heating device, according to an embodiment.

In an embodiment, the battery temperature controller 108 may include a battery surge tank 134, a pump 136, a battery warmer 138, a cooling unit 140, a path switch unit 142, and first and second water temperature sensors 144 and 146.

The battery surge tank 134 may store and supply a coolant that circulates around the battery 102. The pump 136 may bring in the coolant supplied from the battery surge tank 134 to the battery 102 and also bring in the coolant cooled through the cooling unit 140 to the battery 102 again.

The battery warmer 138 is operated by electric power supplied from the battery 102 and may heat the coolant or produce and discharge heat to be directly transmitted to the battery 102 in order to raise the temperature of the battery 102. For example, the battery warmer 138 may be equipped with a plurality of temperature raising heaters. As the coolant is heated by a temperature raising heater and the heated coolant is brought to the battery 102, the temperature of the battery 102 may be raised. At least one of the plurality of temperature raising heaters may be operated based on a battery target temperature. In case the plurality of temperature raising heaters are operated, a quantity of heat from each of the temperature raising heaters may be the same or different according to a battery target temperature. For example, a temperature raising heater may be equipped with a sheath heater. In addition, a temperature raising heater may transmit heat directly to the battery 102.

The cooling unit 140 may cool a coolant that flows out after decreasing the temperature of the battery 102. For example, the cooling unit 140 may be equipped with a radiator, where the coolant flows after being brought out, and a cooling fan that supplies cooling blow to the radiator to cool the coolant. A revolution per minute (RPM) of the cooling fan may be controlled according to a desired temperature that is required for the battery 102.

The path switch unit 142 may control the flow of a coolant outbound from the battery 102. According to an instruction of the processor 126, the path switch unit 142 may make the outbound coolant flow into the cooling unit 140 or return directly to the battery 102 instead. For example, the path switch unit 142 may be configured as a three-way valve. In case the outbound coolant is returned to the battery 102 without mediation of the cooling unit 140, the three-way valve may switch to a 90-degree flow path and thus bring the coolant directly to the battery 102. In case the coolant passes through the cooling unit 140, the three-way valve may switch to a 180-degree flow path and thus make the coolant flow into the cooling unit 140.

The first and second water temperature sensors 144 and 146 may be detectors that measure water temperature at positions of installation. The first water temperature sensor 142 may be located on one side of the battery warmer 138, for example on an entry side of the battery warmer 138. The first water temperature sensor 142 may estimate temperature of the battery 102 by measuring water temperature of the coolant at a point adjacent to the battery 102. In order to accurately estimate temperature of the battery 102, the second water temperature sensor 144 may be located at a point near the battery 102, where the coolant flows out, for example, on an exit side of a cooling tube near the battery 102. The second water temperature sensor 144 is not limited to the above-described location. Rather, the second water temperature sensor 144 may be located in various points that enable accurate temperatures to be measured.

Similar to the battery temperature controller 108, the fuel cell temperature controller 105 is operated by electric power supplied from the fuel cell 104. The fuel cell temperature controller 105 may heat or cool the battery 102 by adjusting temperature of the fuel cell 104 to a desired temperature through a coolant, which circulates around the fuel cell 104, or direct heat transfer. The fuel cell temperature controller 105 may be equipped with a plurality of modules that control the temperature of the fuel cell 104. The temperature of the fuel cell 104 may be raised until a cold start-up condition of the fuel cell 104 is satisfied. For example, the cold start-up condition may be that an estimated temperature of the stacks of the fuel cell 104 and power output of the fuel cell 104 appear to be equal or above a preset temperature and a preset output value respectively. In the present disclosure, for convenience of description, temperature raising processing of the fuel cell by the fuel cell temperature controller 105 may be referred to as power generation cell processing or fuel cell processing.

The fuel cell temperature controller 105 may be equipped with a coolant surge tank storing a coolant for cooling or heating the fuel cell 104, a heating module generating heat for raising temperature of the coolant or transferring the coolant to the fuel cell 104, a cooling module cooling the coolant, and a water temperature sensor module. The cooling module may be a radiator for a coolant circulating around the fuel cell 104 and a heat exchanger that decreases temperature of a coolant through heat exchange with a coolant used in the battery 102 and the indoor air-conditioning unit 112. In order to perceive a situation according to a temperature raising operation, the water temperature sensor module may be installed in coolant flow paths adjacent to a heating module and a cooling module and at a predesignated point of the fuel cell 104.

The vehicle 100 may include load devices 110 and 116, a sensor unit 118, a transceiver 120, a display 122, a memory 124, and a processor 126.

The load devices 110 and 116 may be auxiliary equipment mounted on the vehicle 100 and consume power supplied from the battery 102 by use of an occupant or a user. The load devices 110 and 116 may be a type of electric device for non-driving purpose excluding a driving power system like the wheel drive unit 106 in the present disclosure. In the present disclosure, because an air-conditioning system and a cold and heat control system of a component for user convenience require high output of the battery 102 for scheduled start-up and also affect temperature control of the battery 102 required for output power of the scheduled start-up, for the purpose of emphasizing the systems, the load devices 110 and 116 are described to include the cooling and heating system unit 110 and the accessories 116.

The cooling and heating system unit 110 may include the indoor air-conditioning unit 112 and the component cooling and heating unit 114. The indoor air-conditioning unit 112 may be equipped with a heating device and a cooling device (or air-conditioner) for controlling indoor temperature of the vehicle 100. In the present disclosure, for convenience of explanation, indoor heating processing by a heating device may be abbreviated as heating processing.

Referring to FIG. 3, the indoor air-conditioning unit 112 associated with a heating device according to the present disclosure may be equipped with a heating surge tank 148, a water heating heater 150, a heating unit 152, a heating radiator 154, a water temperature sensor 156, and a path switch unit 158.

The heating surge tank 148 may store and supply a coolant that comes from the water heating heater 150 and circulates through the heating radiator 154. The water heating heater 150 may be operated by electric power supplied from the battery 102 and heat a coolant and provide the heated coolant to the heating unit 152 in order to adjust indoor temperature of the vehicle 100 to a target heating temperature required by a heating request. For example, the water heating heater 150 may be equipped with a plurality of temperature raising heaters. The heating radiator 154 may cool a coolant that is heated by the water temperature heater 150. For example, the heating radiator 154 may be equipped with a radiating module, where the coolant flows after being brought out, and a cooling fan that supplies cooling blow to a radiator to cool the coolant. A revolution per minute (RPM) of the cooling fan may be controlled according to a target heating temperature. The water temperature sensor 156 may be a detector that measures water temperature at a position of installation. The water temperature sensor 156 may be located on one side of the water heating heater 150, for example on an exit side of the water heating heater 150. The water temperature sensor 156 may measure temperature of the heating unit 152. The water temperature sensor 156 is not limited to the above-described location. Rather, the water temperature sensor 156 may be located in various points that enable accurate temperatures to be measured. The path switch unit 158 may control the flow of a coolant circulating around the above-described element. According to an instruction of the processor 126, the path switch unit 158 may make a coolant of the heating surge tank 148 flow to the water heating heater 150 or make a coolant outbound from the heating unit 152 to the water heating heater 150 without flowing into the heating surge tank 148. For example, the path switch unit 158 may be configured as a three-way valve.

The component cooling and heating unit 114 may be a device that cools or heats a component for convenience of riding and driving. Specifically, the component cooling and heating unit 114 may be controlled to heat or cool a component, of the vehicle 100, that contacts a user or removes a driving hinderance in the vehicle 100. For example, the component cooling and heating unit 114 may be a heated steering wheel controller, a heated seat controller, and a heating device for removing frost and moisture from windows and side-view mirrors.

The accessories 116 may be auxiliary devices apart from the cooling and heating system unit 110. The accessories 116 may include, for example, a light system, a seat system, and various devices installed in the vehicle 100.

The sensor unit 118 may be equipped with various types of sensor modules for sensing various states and situations that occur in internal and external environments of the vehicle 100. For example, the sensor unit 118 may be equipped with a location sensor 118a and an ambient temperature sensor 118b.

The location sensor 118a may measure the two-dimensional location and altitude of the vehicle 100, while the vehicle 100 is running, in order to detect a location of the vehicle 100. For example, the location sensor 118a may be a GPS sensor. The GPS sensor may measure a position of the vehicle 100 based on information transmitted from a plurality of satellites. The location sensor 118a is not limited to a GPS sensor. For example, the location sensor 118a may include multiple sensors combining the GPS sensor and another sensor. The ambient temperature sensor 118b may measure an ambient temperature at a current location of the vehicle 100. Though not shown in FIG. 3, the sensor unit 118 may be equipped with an indoor temperature sensor that measures an indoor temperature of the vehicle 100. In addition, the sensor unit 118 may include an image sensor, a light detection and ranging (Lidar) sensor, a radar sensor, a distance sensor, a wheel speed sensor, and a gyro sensor that detects the position and direction of the vehicle 100. The present disclosure mainly describes sensors referred to for description of embodiments of the present disclosure. In some embodiments, the sensors may further include one or more sensors for detecting various situations not listed herein.

The transceiver 120 may support mutual communication with the server 200, the another mobility apparatus (e.g., a neighboring vehicle), a roadside base station, or the user device 300.

In the present disclosure, under control of a communication control unit (CTU), the transceiver 120 may transmit data generated or stored during driving to the server 200 and receive data and a software module transmitted from the server 200. In embodiments of the present disclosure, the vehicle 100 may transmit and receive data used in methods according to embodiments of the present disclosure to and from the outside through the transceiver 120. For example, the transceiver 120 may communicate with the server 200 with respect to data and information according to processing of a scheduled start-up request of the user device 300. In case there is a scheduled start-up request, the transceiver 120 may receive altitude data included in map information used for determining an order of detailed operations associated with battery temperature raising control, such as altitude data of a current location of the vehicle 100 and altitude data in a region within a predetermined range from the location. In addition, in case the sensor 118 of the vehicle 100 is incapable of measuring ambient temperature, the vehicle 100 may receive ambient temperature information of a current location from the server 200.

The display 122 may serve as a user interface. By the processor 126, the display 122 may display an operating state and a control state of the vehicle 100, route/traffic information, a battery state, information on a gas remaining quantity, a content requested by a driver, and the like to be output. The display 122 may be configured as a touch screen capable of sensing a driver input and receive a request of a driver indicated to the processor 126.

The memory 124 may store an application for controlling the vehicle 100 and various data and load the application or read and record data at a request of the processor 126. In embodiments of the present disclosure, the memory 122 may store an application and at least one instruction for controlling temperature raising of the battery 102 at a scheduled start-up request that includes scheduled use associated with a scheduled start-up time and indoor heating.

For example, the memory 124 may store and manage map information that is used to determine an order of detailed operations associated with battery temperature raising control.

In addition, the memory 124 may include data associated with a scheduled time according to a scheduled start-up request, an operation mode of the cooling and heating system unit 110 for which scheduled use is requested, a predicted temperature raising time, and a target battery temperature applied to temperature raising control of the battery 102. The operation mode of the cooling and heating system unit 110 may include whether or not there is an operation request for the indoor air-conditioning unit 112 and/or the component cooling and heating unit 114, a temperature control mode according to a scheduled set value during operation, and/or the like. Irrespective of a user request, the memory 124 may manage a detailed request according to an automatic setting such as an activation setting of a hearing device, designation of an adequate indoor temperature, and activation of seat heating. In addition, the memory 124 may store an air-conditioning heater-on-setting of the indoor air-conditioning unit 112 scheduled by the user device 300, an indoor temperature setting through the air-conditioning heater, and a heated seat control-on-setting.

The processor 126 may perform overall control of the vehicle 100. The processor 126 may be configured to execute an application and an instruction stored in the memory 124. In embodiments of the present disclosure, the processor 126 may receive a scheduled start-up request including a command associated with indoor heating and a scheduling request of the vehicle, by using an application, an instruction and data stored in the memory 124. In case a cold start-up condition is satisfied, the processor 126 may determine an order of a discharge temperature raising operation associated with battery temperature raising control and a temperature raising operation of the fuel cell 104 for charging the battery 102 based on a battery charge state. In addition, the processor 126 may control temperature raising of the battery 102 by using the discharge temperature raising operation and the temperature raising operation of the fuel cell 104 according to the order. The discharge temperature raising operation may include at least one of indoor heating processing and battery warm-up processing.

As an example, the above-described operation may be performed in at least a part of the processor 126, for example, in at least one processor module and in at least a part of the memory 130.

As another example, the operation may be performed in a plurality of processing modules and a memory incorporated in each module. In an example, the plurality of processing modules and the embedded memory may constitute the processor 126 and the memory 124.

For example, the plurality of processing modules may consist of individual processing modules for controlling each member of the vehicle 100 and a higher processing module for managing the individual processing modules at a higher level. In examples, the individual processing modules for controlling and managing the battery 102 may be a battery management system (BMS) 128 and a fuel cell control unit (FCU) 132 for controlling and managing the fuel cell 104. In an example, an individual processing module for controlling the transceiver 120 and performing data communication may be a CTU.

The higher processing module for managing all the individual processing modules may be a vehicle control unit (VCU) 130. The BMS 126 may transmit a coolant temperature for estimating cell temperature of the battery 102, a charge state of the battery 102, and states of temperature raising heaters installed in the battery warmer 136 to the VCU 130. The BMS 128 may receive data and a command for controlling battery temperature raising control from the VCU 130. For example, the BMS 128 may receive, as a determination result regarding whether or not to raise temperature of the battery 102, a main relay on/off command for the battery 102, an operation command for a temperature raising heater, and/or the like from the VCU 130. The FCU 132 may transmit a stack temperature of the fuel cell 104, a coolant temperature, and a control state of a heating module to the VCU 130. The VCU 130 may control the fuel cell temperature controller 105 based on the above-described data so that temperature raising processing of the fuel cell 104 may be executed. In addition, in order to execute indoor heating processing, the VCU 130 may control a heating device based on an indoor temperature measured from an indoor temperature sensor, an ambient temperature, and a temperature of coolant flowing from or into the water heating heater 150 of the heating device.

Based on the above description, battery temperature raising control according to a scheduled start-up request is performed through data exchanged among the BMS 128, the VCU 130 and the CTU and processing therein. However, in the present disclosure, for convenience of explanation, the processor 126 including these processing modules is described to process the battery temperature raising control. Although a detailed process for the above-described processing is described mainly through the processor 126, a processing module in charge of the detailed process may be clearly inferred from the above description. Accordingly, in the present disclosure, a processor may mean a conceptual controller including a single processing module or a plurality of processing modules.

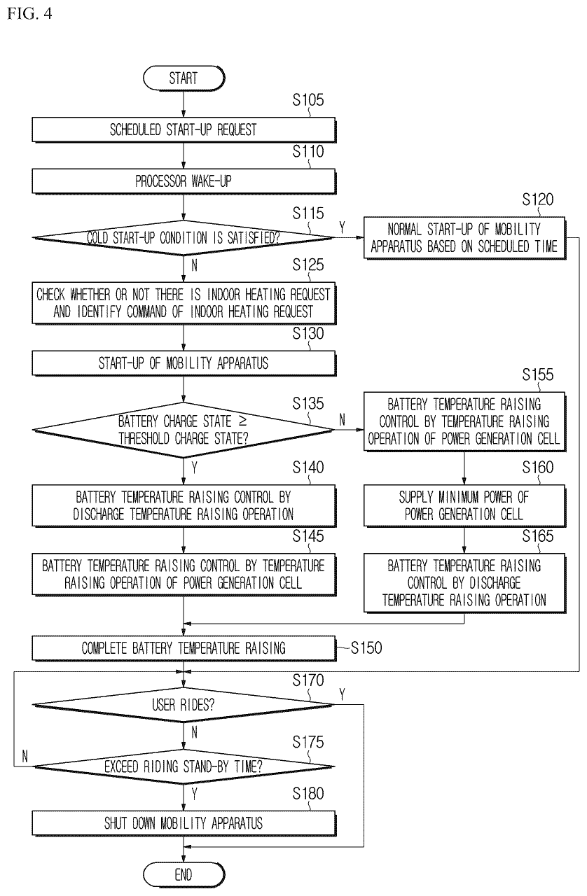

The above-described processing of the processor 126 is described in more detail below with reference to FIGS. 4-10.

Referring to FIG. 4, a battery controlling method based on ambient temperature in scheduled start-up, according to an embodiment of the present disclosure, is described in more detail. FIG. 4 is a flowchart of a battery controlling method for scheduled start-up, according to an embodiment.

In an operation S105, the server 200 may receive a scheduled start-up request that is required from a user.

For example, the user may create the scheduled start-up request by using an application of the user device 300, and the user device 300 may transmit the scheduled start-up request to the server 200. The scheduled start-up request may include a scheduling request of the vehicle 100. The scheduling request of the vehicle 100 may include a scheduled time at which start-up is initiated before the user actually rides. A scheduled use request time may be a time at which the user wishes to use the vehicle 100 without limited output. Accordingly, as the start-up may be completed before the scheduled time and battery temperature is completely raised during a planned temperature raising time, the user may use the vehicle 100 without limited output of the vehicle 100 at the scheduled time. For battery temperature raising that is necessary for preventing limited output of the vehicle 100, start-up may be initiated before the scheduled time. That is, a start-up initiation time may precede the scheduled time.

In addition, the scheduled start-up request may further include a user's scheduled use request for the cooling and heating system unit 110, such as a command associated with indoor heating. The command associated with indoor heating may be an instruction associated with controlling a heating device according to a request of the user device 300 or an automatic setting by the processor 126. The command may be an instruction associated with activating or deactivating indoor heating, a request source option indicating activation, a heating instruction based on a target heating temperature required by the request source option, and/or the like. The request source option (or option) means a device requiring activation. The device requiring activation may be, for example, the user device 300 or the processor 126 that executes a setting of automatically activating the heating device.

In an operation S110, the processor 126 of the vehicle 100 may wake up before a scheduled time at the scheduled start-up request received from the server 200 and identify the user's demand in the scheduled start-up request.

Unlike a start-up operation for travel drive of the vehicle 100, the wake-up of the processor 126 may be an operation of activating the processor 126 and a relevant module of the vehicle 100 for specific processing that consumes lower power than start-up. The relevant module may be the transceiver 120, the sensor unit 118, and the memory 124.

In an operation S115, in order to check whether or not to raise battery temperature used for scheduled start-up, the processor 126 may determine whether or not a cold start-up condition is satisfied.

For example, the cold start-up condition may be satisfied when an ambient temperature is equal to or lower than a cold start-up temperature. The cold start-up temperature may be designated based on the performance and specification of the vehicle 100 and an experimental method. The cold start-up condition is not limited to the above description but may be set as various conditions.

In an operation S120, in case the ambient temperature is higher than the cold start-up temperature, the processor 126 may execute normal start-up for the vehicle 100 without battery temperature raising processing based on the scheduled time.

On the other hand, in case the ambient temperature is equal to or lower than the cold start-up temperature, the processor 126 may check whether or not there is an indoor heating request and identify a command of the indoor heating request in an operation S125.

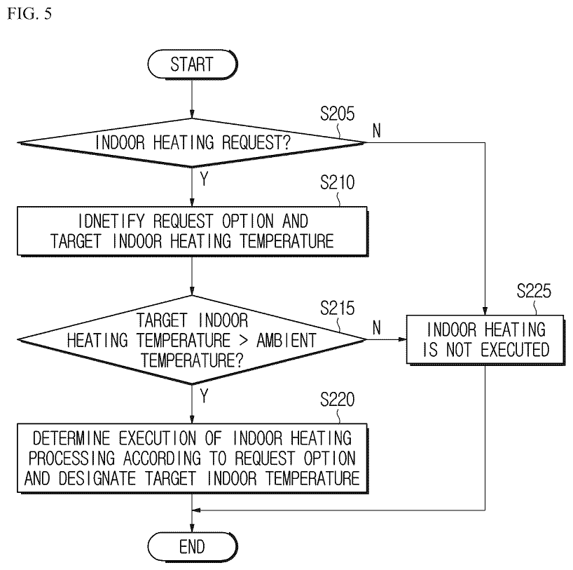

Operation S125, according to an embodiment, is described in more detail below with reference to FIG. 5. FIG. 5 is a flowchart of a method of identifying an indoor heating request, according to an embodiment.

Referring to FIG. 5, in an operation S205, The processor 126 may check whether or not there is an indoor heating request. The presence or absence of the request may be checked through an instruction associated with activation or deactivation of indoor heating processing included in the scheduled start-up request. In an operation S210, in case there is activation of indoor heating processing, the processor 126 may identify a request option (or request source option) for indicating the activation or a target indoor temperature required in the request option. The target indoor heating temperature may be identified from a temperature set by the user device 300 or by an automatic setting of the processor 126. In an operation S215, the processor 126 may check whether or not the target indoor heating temperature is higher than an ambient temperature at a location of the vehicle 100. In the case that the target indoor heating temperature is higher, the processor 126 may ultimately determine execution of indoor heating processing according to the request option and finally set a target indoor temperature according to the execution of processing in an operation S220.

In an operation S225, in the case that the indoor heating processing is deactivated by the user or an automatic setting or in case the target indoor temperature is equal to or lower than the ambient temperature, the processor 126 may determine that the indoor heating processing is not to be executed.

Referring to FIG. 4 again, responding to the arrival of the start-up initiation time, the processor 126 may automatically initiate start-up of the vehicle 100 in an operation S130.

In an operation S135, the processor 126 may check a charge state of the battery 102 in the turned-on vehicle 100 and identify whether or not the charge state is equal to or above a threshold charge state.

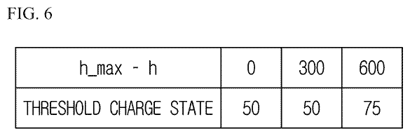

The threshold charge state may be set based on a current location of the vehicle 100. For example, the threshold charge state may be defined as a charge state that is required according to a difference between a current altitude at the location and a highest altitude in a region within a predetermined range from the location. FIG. 6 is a view exemplifying a table map of a threshold charge state. In FIG. 6, h may be a current altitude at a current location of the vehicle 100 obtained from the location sensor 118a and map information, and h_max may be a highest altitude in a region within a predetermined range from the current location. In the case that the highest altitude is lower than the current altitude, the threshold charge state may be 50%. On the other hand, as the highest altitude increases and thus the difference between altitudes increases, a charge state value of the threshold charge state may increase.

In an embodiment, the processor 126 may determine an order of a discharge temperature raising operation associated with battery temperature raising control and a temperature raising operation of a power generation cell for charging the battery based on comparison between a battery charge state and the threshold charge state. The present disclosure exemplifies determination of the order through the comparison of those two charge states, but the order may be determined by various types of analysis about the battery charge state.

In the case that the battery charge state is equal or above the threshold charge state (Y in the operation S135), the processor 126 may determine that temperature raising of the battery 102 is to be executed in order of the discharge temperature raising operation and the temperature raising operation of the power generation cell (e.g., the fuel cell 104). On the other hand, in the case that the battery charge state is below the threshold charge state (N in the operation S135), the processor 126 may determine that the temperature raising of the battery 102 is to be executed in order of the temperature raising operation of the power generation cell (e.g., the fuel cell 104) and the discharge temperature raising operation.

When the discharge temperature raising operation precedes according to Y in the operation S135, the processor 126 may control the temperature raising of the battery 102 by the discharge temperature raising operation in an operation S140.

In the case that there is an indoor heating request, the discharge temperature raising operation may be processed by combining indoor heating processing and battery warm-up processing. As described above, the indoor heating processing may be performed by a heating device of the indoor air-conditioning unit 112, and the battery warm-up processing may be executed by the battery temperature controller 108. The discharge temperature raising operation may be heating the battery 102 by heat generation from a discharge current of the battery 102 discharged to supply power to the heating device and a specific module of the battery temperature controller 108 such as the water heating heater 150 and the battery warmer 138 through internal resistance of the battery 102, while the battery 102 is not charged by the fuel cell 104. In addition, an operation of heating the battery 102 through heat transfer from the heating device and a specific module of the battery temperature controller 108 may also be considered as the discharge temperature raising operation. While the discharge temperature raising operation is executed, the processor 126 may control the fuel cell 104 to generate and supply minimum power to the battery 102. For example, the minimum power may be 3 kW corresponding to a minimum gas supply amount.

The discharge temperature raising operation using two processings may be performed based on time required for the temperature raising operation of the fuel cell 104 and the battery temperature raising control. For example, a temperature raising time of the fuel cell 104 may be a time required for satisfying a cold start-up state condition from a current state of the fuel cell 104. For example, the current state may be an estimated stack temperature of the fuel cell 104, an ambient temperature, and an estimated power generation output, and the cold start-up state condition may be a temperature required for the stack of the fuel cell 104 and a required power generation output.

For example, the battery temperature raising control may be processing for raising a battery temperature up to a target battery temperature by using a combination the discharge temperature raising operation and the temperature raising operation of the fuel cell. A required time for the battery temperature raising control may be an expected time for the battery temperature to reach a target battery temperature by the combination of the discharge temperature raising operation and the temperature raising operation of the fuel cell 104. The battery temperature may be a lowest temperature among temperatures detected from a plurality of predetermined portions of the battery 102. For example, the temperatures of the predetermined portions may be temperatures detected from multiple portions among the cell, module and pack of the battery 102.

As for the temperature raising operation of the fuel cell 104, the cold start-up state condition and heat generated from the battery 102 according to the condition may be considered. As for the processing involved in the discharge temperature raising operation, a target heating temperature and heat generated from the battery 102 due to each processing may be considered. The required time for the battery temperature raising control may be estimated based on the factors considered above. Accordingly, a time spent in the discharge temperature raising operation may be estimated as a difference of required time between the battery temperature raising control and the temperature raising processing of the fuel cell 104.

While raising the temperature of the battery 102 by the discharge temperature raising operation using two processings, if completion or cessation of each processing is notified, the processor 126 may deactivate the notified processing and control the temperature raising of the battery 102 according to unnotified processing.

For example, if indoor heating processing is completed, the temperature raising of the battery through the indoor heating processing is ceased, and the temperature of the battery 102 may be raised by battery warm-up processing. The completion of the indoor heating processing may be notified when the indoor temperature reaches the target indoor temperature.

As another example, while the battery warm-up processing is being executed, if a coolant temperature heating the battery 102 is equal to or higher than an upper temperature limit, the battery warm-up processing may be ceased, and the temperature of the battery 102 may be raised by the indoor heating processing. For example, the heating coolant temperature may be a water temperature of the first water temperature sensor 144 that detects temperature of a coolant flowing from the battery warmer 138. In the case that a coolant circulating around the battery temperature controller 108 at high temperature flows to the battery 102, a local temperature of the battery 102 may be abnormally raised, and thus the battery 102 may have durability degraded in a local portion. Accordingly, in the case that a coolant used in the battery 102 has an excessively high temperature, the battery warm-up processing may not be executed.

When the cessation or completion of each processing is notified or a required time expected for the discharge temperature raising processing is arrived, the battery temperature raising control by the battery temperature raising processing may end.

In an embodiment, in the case that there is no indoor heating request or non-execution state of the indoor heating processing occurs, the discharged temperature raising operation may deactivate the indoor heating processing and be executed by the battery warm-up processing. The non-execution state may be a situation where the indoor heating processing is not executed as the ambient temperature is higher than the target indoor heating temperature even if there is a heating request. Herein, a time for performing the battery warm-up processing and the cessation of the processing are the same as described above, except what is related to the indoor heating processing.

In an operation S145, the processor 126 may control temperature raising of the battery 102 by a subsequent temperature raising operation of a power generation cell (fuel cell 104) (.

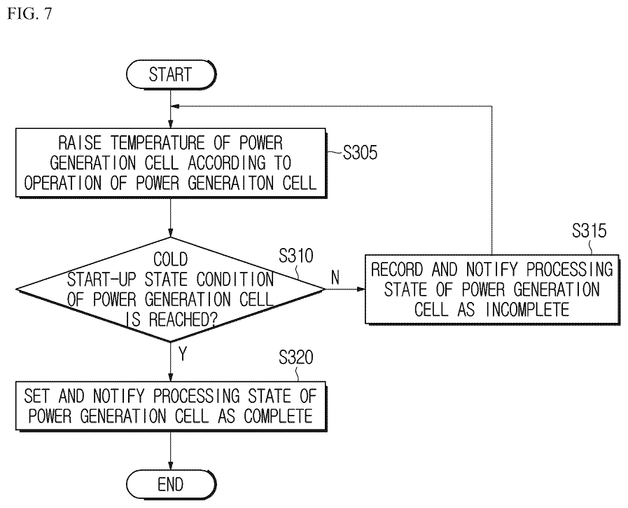

The operation S145, according to an embodiment, is described in more detail below with reference to FIG. 7. FIG. 7 is a flowchart of a process of processing a temperature raising operation of a power generation battery, according to an embodiment.

Referring to FIG. 7, in an operation S305, the processor 126 may raise temperature of the power generation cell (e.g., fuel cell 104) according to operation of the fuel cell 104.

Temperature raising of the fuel cell 104 may be performed by using the fuel cell temperature controller 105, which may proceed as described in FIG. 1. Power of the fuel cell 104, which is generated from the temperature raising process of the fuel cell 104, may be supplied to the battery 102 as surplus charging power. Electric current according to charging generates heat through internal resistance of the battery 102, and the heat may heat the battery 102. In addition, an operation of transferring heat discharged from a heating module for temperature raising of the fuel cell 104 to the battery 102 may also be considered as a temperature raising operation of the battery 102 according to temperature raising of the fuel cell 104.

In an operation S310, the processor 126 may determine whether the cold start-up state condition of the fuel cell 104 is satisfied by the temperature raising operation of the fuel cell 104. In the case that the condition is not satisfied, the fuel cell temperature controller 105 may record a processing state of the fuel cell 104 as incomplete with respect to temperature raising of the fuel cell 104 and notify the processing state to the processor 126 in an operation S315. Accordingly, the temperature raising operation of the fuel cell 104 is maintained, and thus the temperature raising control of the battery 102 may be continuously executed. In this case, even when the battery temperature reaches a target battery temperature, the temperature raising operation of the fuel cell 104 may continue until the cold start-up state condition is satisfied.

On the other hand, in the case that the cold start-up state condition is satisfied, the fuel cell temperature controller 105 may set the processing state of the fuel cell 104 as complete with respect to the temperature raising of the fuel cell 104 and notify the processing state to the processor 126 in an operation S320. In response to the complete processing state of the fuel cell 104, the processor 126 may end the temperature raising operation of the fuel cell 104.

Referring to FIG. 4 again, by ending the temperature raising operation of the fuel cell 104, the processor 126 may determine that the battery temperature raising control is completed in an operation S150. In this case, the processor 126 may check whether or not a battery temperature is equal to or higher than a target battery temperature. If the battery temperature does not reach the target battery temperature, the processor 126 may additionally execute battery warm-up processing until the target battery temperature is reached.

Referring still to FIG. 4, in the case that a temperature raising operation of the fuel cell 104 precedes according to N in the operation S135, the processor 126 may control temperature raising of the battery 102 by the temperature raising operation of the fuel cell 104 in an operation S155. The temperature raising operation of the fuel cell 104 may be the same as described above in connection with the operation S145.

In an operation S160, the processor 126 may control the fuel cell 104 to generate and supply minimum power to the battery 102. For example, the minimum power may be 3 kW corresponding to a minimum gas supply amount.

In an operation S165, the processor 126 may control temperature raising of the battery 102 by a subsequent discharge temperature raising operation.

Similar to the operation S140, according to whether or not there is an indoor heating request and an estimated indoor temperature, indoor heating processing may be selectively included in the discharge temperature raising operation. For example, in the case that there is no indoor heating request or non-execution state of the indoor heating processing occurs, the temperature raising of the battery 102 may depend on the battery warm-up processing without activating the indoor heating processing. In this case, the battery warm-up processing may be performed until the battery temperature reaches the target battery temperature. However, in the case that the cessation of the battery warm-up processing is notified as described in the operation S140, the battery warm-up processing may be ceased, and the battery temperature raising operation may end.

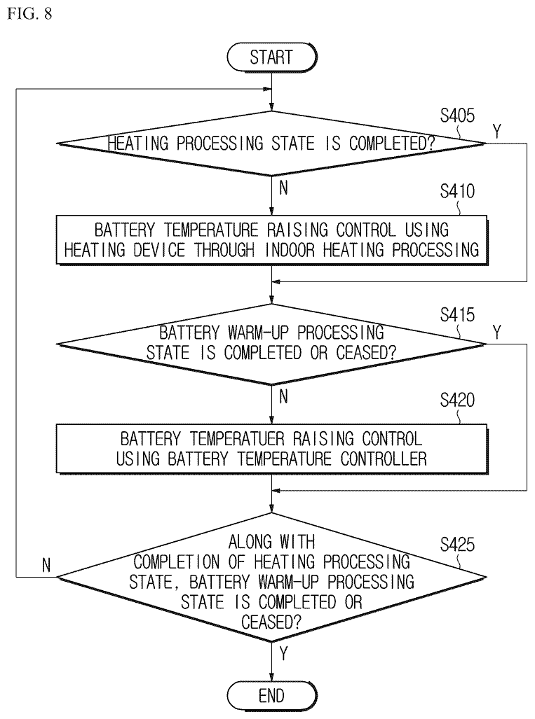

The operation S165, where an indoor heating request is definitely executed without non-execution state, according to an embodiment, is described in more detail below with reference to FIGS. 8-10. FIG. 8 is a flowchart of a process of processing battery temperature raising that follows a discharge temperature raising operation, according to an embodiment.

Referring to FIG. 8, in an operation, the processor 126 may check whether or not a heating processing state by a heating device is completed.

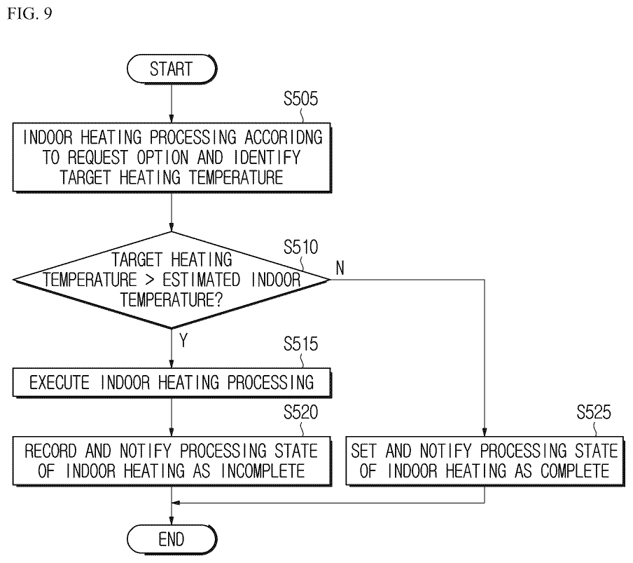

FIG. 9 is a flowchart of a process of processing an operation of indoor heating, according to an embodiment. As for completion of the heating processing state, referring to FIG. 9, the processor 126 may perform indoor heating according to a request option in a heating device and identify a target heating temperature according to the option in an operation S505. In an operation S515, in the case that the target heating temperature is higher than an estimated indoor temperature (Y in an operation S510), the processor 126 may continuously execute indoor heating processing. When the processing is continuously executed, the indoor air-conditioning unit 112 of the heating device may record a processing state of indoor heating as incomplete and notify the processing state to the processor 126. In the case that the target heating temperature is lower than the estimated indoor temperature (N in the operation S510), the indoor hearing processing may be finished by the processor 126. In an operation S525, the indoor air-conditioning unit 112 may set a processing state of indoor heating as complete and notify the processing state to the processor 126.

Based on the notified processing state of indoor heating, the processor 126 may identify the heating processing state as complete.

Referring to FIG. 8 again, in the case that the processing state of indoor heating is not notified as complete, the processor 126 may control temperature raising of the battery 102 by using indoor heating processing of a heating device in an operation S410, and then proceed to an operation S415. In the case that the processing state of indoor heating is notified as complete, the processor 126 may proceed to the operation S415.

In the operation S415, the processor 126 may check whether the battery warm-up processing state is completed or ceased.

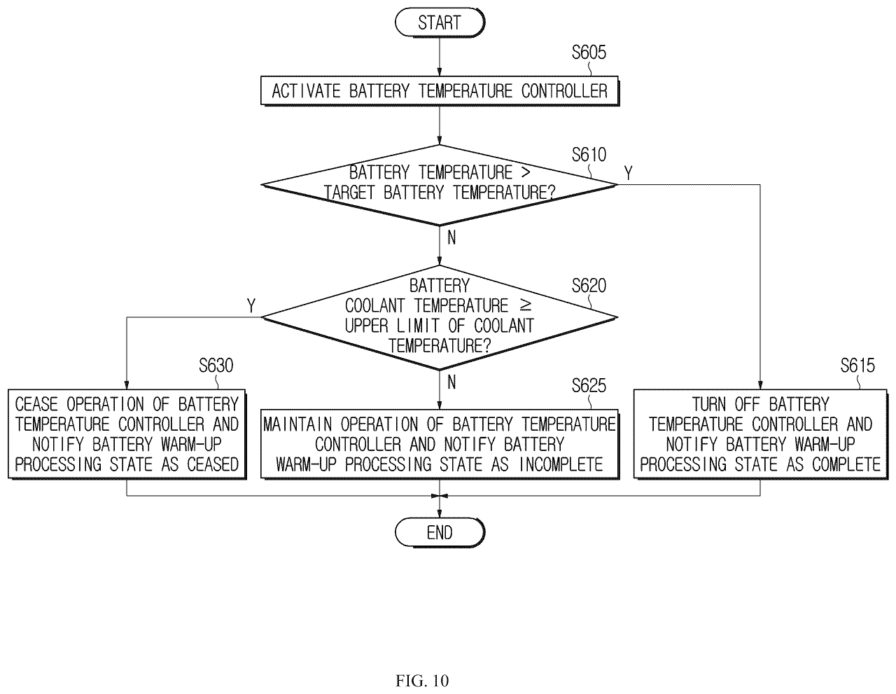

The operation S415, according to an embodiment, is described in more detail below with reference to FIG. 10. FIG. 10 is a flowchart of a process of processing an operation of a battery temperature controller, according to an embodiment.

Referring to FIG. 10, in an operation S605, the processor 126 may activate the battery temperature controller 108 such as the battery warmer 138 by a discharge temperature raising operation.

In an operation S615, in the case that a battery temperature is raised above a target battery temperature through battery warm-up processing, the battery temperature controller 108 may be off to end the battery warm-up processing and notify a battery warm-up processing state to the processor 126 as complete.

On the other hand, in the case that the battery temperature is lower than the target battery temperature, the processor 126 may determine whether or not a battery coolant temperature is equal to or higher than an upper limit of coolant temperature in an operation S620. In the case that the battery coolant temperature is lower than the upper limit of coolant temperature, the battery temperature controller 108 may maintain the battery warm-up processing by the processor 126, and the battery temperature controller 108 may notify a battery warm-up processing state to the processor 126 as incomplete in an operation S625. On the other hand, in the case that the battery coolant temperature is equal to or higher than the upper limit of coolant temperature, the battery temperature controller 108 may cease the battery warm-up processing by the processor 126, and the battery temperature controller 108 may notify a battery warm-up processing state to the processor 126 as ceased in an operation S625.

Based on a notified battery warm-up processing state, the processor 126 may identify completion, incompletion, or cessation of the battery warm-up processing.

Referring to FIG. 7 again, in the case that the battery warm-up processing state is not notified as complete or ceased, the processor 126 may control temperature raising of the battery 102 by using the battery warm-up processing of the battery temperature controller 108 in an operation S420 and then proceed to an operation S425. In the case that the battery warm-up processing state is notified as complete or ceased, the processor 126 may proceed to the operation S425.

In the operation S425, the processor 126 may check whether or not the completion or cessation of the battery warm-up processing state is present as well as the completion of the heating processing state. In the case that both states are present, both the indoor heating processing and the battery warm-up processing are finished, and the discharge temperature raising operation may also be finished. In the case that any one of the states is absent, operations S405-S420 may be repeated.

Referring to FIG. 4 again, by ending the temperature raising operation of the fuel cell 104, the processor 126 may determine that the battery temperature raising control is completed in an operation S150. In this case, the processor 126 may check whether or not a battery temperature is equal to or higher than a target battery temperature. If the battery temperature does not reach the target battery temperature, the processor 126 may additionally execute battery warm-up processing until the target battery temperature is reached.

In an operation S170, the processor 126 may wait for a user to ride. In an operation S175, the processor 126 may determine whether or not a non-riding state exceeds a ride stand-by time. In the case that riding is detected within the ride stand-by time, the processor 126 may maintain start-up of the vehicle 100. On the other hand, in the case no riding is detected in the ride stand-by time after temperature raising is completed, the processor 126 may shut down the vehicle 100 in an operation S180.

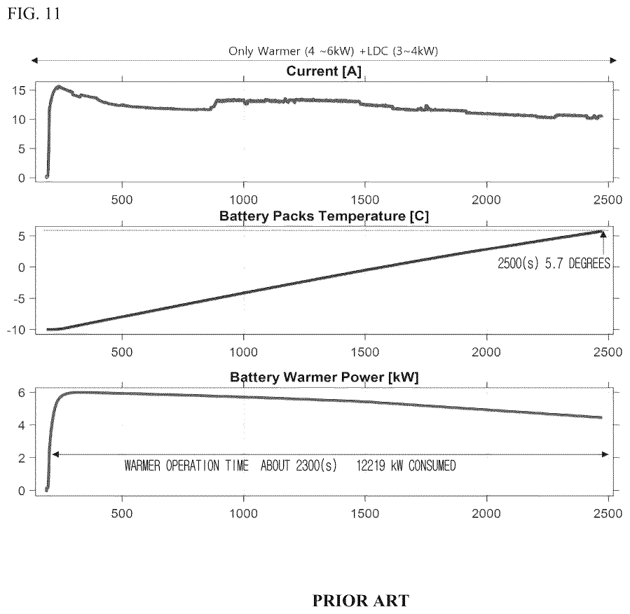

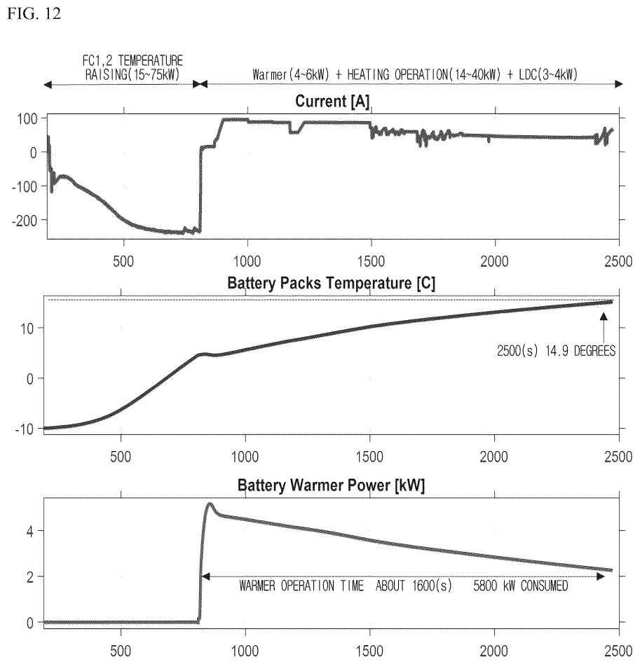

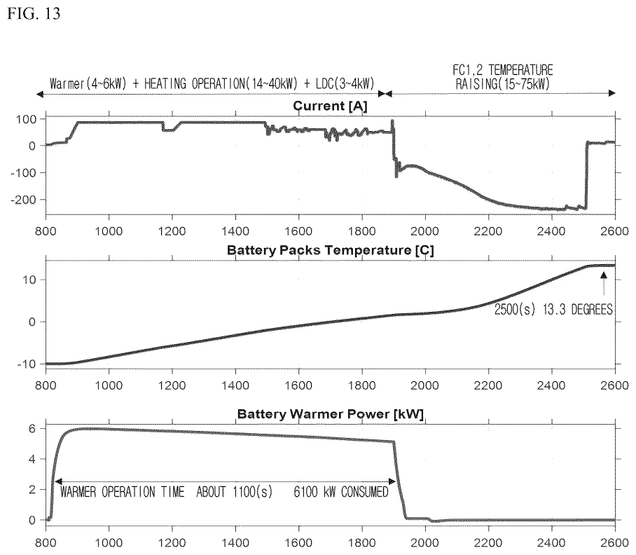

Referring to FIG. 11-13, the conventional battery temperature raising control and the battery temperature raising control according to embodiments is described, and some advantages of embodiments is described based on validation data. FIG. 11 is a view schematically showing consumed currents, battery temperature rise, consumed currents of a battery warmer in accordance with conventional battery temperature raising control. FIG. 12 is a view schematically showing consumed currents, battery temperature rise, consumed currents of a battery warmer in accordance with battery temperature raising control when a battery charge state is lower than a threshold charge state according to an embodiment. FIG. 13 is a view schematically showing consumed currents, battery temperature rise, consumed currents of a battery warmer in accordance with battery temperature raising control when a battery charge state is higher than a threshold charge state according to an embodiment.

The conventional battery temperature raising control according to FIG. 11 is executed only by the battery warmer 138 of the battery temperature controller 108. A battery state is SOC 90% exceeding a threshold charge state, an ambient temperature around the vehicle 100 is −20 degrees Celsius, and a lowest temperature in multiple portions of the battery 102 is −10 degrees Celsius. In embodiments of FIGS. 12 and 13, an ambient temperature and a lowest battery temperature are the same. In the embodiment of FIG. 12, a battery state below a threshold charge state is SOC 50%. Un the embodiment of FIG. 13, a battery state exceeding a threshold charge state is SOC 85%. In the embodiment of FIG. 12, battery temperature raising control is performed in order of a temperature raising operation of the fuel cell 104 and a discharge temperature raising operation. In the embodiment of FIG. 13, battery temperature raising control is performed in order of a discharge temperature raising operation and a temperature raising operation of the fuel cell 104, which is a reversed order of FIG. 12. In the embodiments of FIGS. 12 and 13, the discharge temperature raising operation includes a battery temperature raising operation by indoor heating processing and battery warm-up processing.

In the embodiments of FIGS. 12 and 13, the battery temperature is raised higher than the conventional one of FIG. 11, while the power consumption and use time of the battery warmer 138 are significantly reduced as compared with the conventional ones. According to these embodiments, energy efficiency of a battery temperature raising process may be improved during cold scheduled start-up.

While the methods of the present disclosure described above are represented as a series of operations for clarity of description, the present disclosure is not intended to limit the order in which the steps are performed. In some embodiments, the operations may be performed simultaneously or in different order as necessary. In order to implement the methods according to embodiments of the present disclosure, the described operations may further include other operations, may include different operations in place of some of the described operations, and/or may include other additional operations in place of and/or in addition to some of the described operations.

The various embodiments of the present disclosure are not a list of all possible combinations and are intended to describe representative aspects of the present disclosure. The matters described in connection with the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for controlling a battery for scheduled start-up, the method comprising:
receiving a scheduled start-up request that includes a command associated with indoor heating and a scheduling request of a mobility apparatus;
determining, in relation to battery temperature raising control, an order of a discharge temperature raising operation and a temperature raising operation of a power generation cell charging the battery, based on a battery charge state, when a cold start-up condition is satisfied; and
controlling temperature raising of the battery by using the discharge temperature raising operation and the temperature raising operation of the power generation cell according to the order, wherein the discharge temperature raising operation includes at least one of indoor heating processing and battery warm-up processing.

2. The method of claim 1, wherein the cold start-up condition is satisfied when an ambient temperature is equal to or lower than a cold start-up temperature.

3. The method of claim 1, wherein determining the order based on the battery charge state includes determining the order based on a comparison between the battery charge state and a threshold charge state, wherein the threshold charge state is set based on a location of the mobility apparatus.

4. The method of claim 3, wherein the threshold charge state is a charge state that is required according to a difference between a current altitude at the location and a highest altitude in a region within a predetermined range from the location.

5. The method of claim 3, wherein determining the order based on the battery charge state further includes:
determining to execute temperature raising control of the battery in an order of the discharge temperature raising operation and the temperature raising operation of the power generation cell, when the battery charge state is equal or higher than the threshold charge state; and
determining to execute the temperature raising control of the battery in an order of the temperature raising operation of the power generation cell and the discharge temperature raising operation, when the battery charge state is lower than the threshold charge state.

6. The method of claim 1, wherein controlling the temperature raising of the battery includes:
deactivating the temperature raising control of the battery by the indoor heating processing, in response to absence of an indoor heating request in the command, occurrence of a non-execution state of the indoor heating processing, or completion of the indoor heating processing; and
executing the battery temperature raising control by the battery warm-up processing.

7. The method of claim 1, wherein execution of the battery warm-up processing stops when a water temperature heating the battery is equal to or higher than an upper temperature limit.

8. The method of claim 1, wherein controlling the temperature raising of the battery is performed until a battery temperature reaches a target battery temperature, wherein the battery temperature is a lowest temperature among temperatures detected from a plurality of predetermined portions of the battery.

9. The method of claim 1, wherein, when the order is determined as an order of the discharge temperature raising operation and the temperature raising operation of the power generation cell, the discharge temperature raising operation is performed based on a time required for the temperature raising operation of the power generation cell and the battery temperature raising control.

10. The method of claim 1, wherein the temperature raising operation of the power generation cell is performed until a cold start-up state condition of the power generation cell is satisfied.

11. A mobility apparatus comprising:
a battery configured to supply power to the mobility apparatus;
a power generation cell configured to charge the battery;
a memory configured to store at least one instruction; and
a processor configured to execute the at least one instruction stored in the memory,
wherein the processor is further configured to
receive a scheduled start-up request that includes a command associated with indoor heating and a scheduling request of the mobility apparatus,
determine, in relation to battery temperature raising control, an order of a discharge temperature raising operation and a temperature raising operation of a power generation cell charging the battery, based on a battery charge state, when a cold start-up condition is satisfied, and
control temperature raising of the battery by using the discharge temperature raising operation and the temperature raising operation of the power generation cell according to the order, wherein the discharge temperature raising operation includes at least one of indoor heating processing and battery warm-up processing.

12. The mobility apparatus of claim 11, wherein the cold start-up condition is satisfied when an ambient temperature is equal to or lower than a cold start-up temperature.

13. The mobility apparatus of claim 11, wherein the processor is configured to determine the order based on a comparison between the battery charge state and a threshold charge state, wherein the threshold charge state is set based on a location of the mobility apparatus.

14. The mobility apparatus of claim 13, wherein the threshold charge state is a charge state that is required according to a difference between a current altitude at the location and a highest altitude in a region within a predetermined range from the location.

15. The mobility apparatus of claim 13, wherein the processor is configured to determine the order based on the battery charge state at least by:
determining to execute temperature raising control of the battery in an order of the discharge temperature raising operation and the temperature raising operation of the power generation cell, when the battery charge state is equal or higher than the threshold charge state; and
determining to execute the temperature raising control of the battery in an order of the temperature raising operation of the power generation cell and the discharge temperature raising operation, when the battery charge state is lower than the threshold charge state.

16. The mobility apparatus of claim 11, wherein the processor is configured to control the temperature raising of the battery at least by:
deactivating the control of the temperature raising of the battery by the indoor heating processing, in response to absence of an indoor heating request in the command, occurrence of a non-execution state of the indoor heating processing, or completion of the indoor heating processing; and
executing the battery temperature raising control by the battery warm-up processing.

17. The mobility apparatus of claim 11, wherein the processor is configured to stop the battery warm-up processing when a water temperature heating the battery is equal to or higher than an upper temperature limit.

18. The mobility apparatus of claim 11, wherein the processor is configured perform control of the temperature raising of the battery until a battery temperature reaches a target battery temperature, wherein the battery temperature is a lowest temperature among temperatures detected from a plurality of predetermined portions of the battery.

19. The mobility apparatus of claim 11, wherein the processor is configured to, when the order is determined as an order of the discharge temperature raising operation and the temperature raising operation of the power generation cell, perform the discharge temperature raising operation based on a time required for the temperature raising operation of the power generation cell and the battery temperature raising control.

20. The mobility apparatus of claim 11, wherein the processor is configured to perform the temperature raising operation of the power generation cell until a cold start-up state condition of the power generation cell is satisfied.
